(19) United States
(12) Patent Application Publication
(10) Pub. No.: US 2020/0088082 A1
(43) Pub. Date: Mar. 19, 2020

(54) EXHAUST SYSTEM AND METHOD OF OPERATING THE SAME

(71) Applicant: GM GLOBAL TECHNOLOGY OPERATIONS LLC, DETROIT, MI (US)

(72) Inventors: Serena Tordin, Settimo Torinese (IT); Fabio Sessa, Turin (IT); Lorenzo Pataccia, Turin (IT); Francesco Castorina, Turin (IT)

(21) Appl. No.: 16/130,493

(22) Filed: Sep. 13, 2018

(51) Int. Cl. F01N 11/00; F02D 9/10; F02D 41/22; F02D 9/04

(52) U.S. Cl. CPC F01N 11/002; F02D 9/105; F02D 9/04; F02D 9/1065; F02D 41/221

(57) ABSTRACT

An exhaust system for a vehicle and method of operating the exhaust system. The exhaust system comprises an internal combustion engine, an exhaust throttle valve, and a pressure sensor. The method comprises the steps of: outputting an exhaust gas from the internal combustion engine; determining a flow factor for the exhaust throttle valve; conducting a diagnostic pressure analysis using one or more pressure readings from the pressure sensor; estimating a stuck position for the exhaust throttle valve; determining a flow limit based on the estimated stuck position; and mitigating one or more exhaust system effects based on the flow limit and/or the estimated stuck position.

The field of technology generally relates to exhaust systems for vehicles and, more particularly, to exhaust throttle valves in the exhaust systems.

The exhaust throttle valve of the exhaust system helps to control release of exhaust gases from an internal combustion engine of a vehicle. Additionally, the exhaust throttle valve can help control the amount of exhaust gas that is recirculated in an exhaust gas recirculation (EGR) system. Failures in the exhaust throttle valve can create overpressure in the exhaust line. Efficient detection of failures in the exhaust throttle valve can advantageously prevent or mitigate damage to other components in the exhaust system.

### SUMMARY

According to one embodiment, there is provided a method of operating an exhaust system. The exhaust system comprises an internal combustion engine, an exhaust throttle valve, and a pressure sensor. The method comprises the steps of: outputting an exhaust gas from the internal combustion engine; determining a flow factor for the exhaust throttle valve; conducting a diagnostic pressure analysis using one or more pressure readings from the pressure sensor; estimating a stuck position for the exhaust throttle valve; determining a flow limit based on the estimated stuck position; and mitigating one or more exhaust system effects based on the flow limit and/or the estimated stuck position.

According to various embodiments, this method may further include any one of the following steps or features or any technically-feasible combination of these steps or features:
the flow factor is proportional to a mass flow rate through the exhaust throttle valve and an exhaust gas temperature;
the flow factor is also proportional to a downstream pressure measure;
the pressure sensor is a downstream pressure sensor, and wherein the one or more pressure readings are obtained from downstream of the exhaust throttle valve and used to determine the downstream pressure measure;
the flow factor is used to determine a worst-case pressure estimate;
the diagnostic pressure analysis comprises a threshold step of determining whether the worst-case pressure estimate is higher than a hardware pressure limit;
when the worst-case pressure limit is higher than the hardware pressure limit, the diagnostic pressure analysis determines whether a current pressure measure from the one or more pressure readings is higher than the hardware pressure limit;
the pressure sensor is an upstream pressure sensor and the one or more pressure readings are obtained from upstream of the exhaust throttle valve;
the step of estimating a stuck position for the exhaust throttle valve uses a flow reading or calculation, one or more temperature readings, and the one or more pressure readings;
the step of mitigating one or more exhaust system effects includes activating a diagnostic trouble code;
the step of mitigating one or more exhaust system effects includes determining a modified maximum torque for the internal combustion engine; and/or
the step of adjusting a torque command for the internal combustion engine based on the modified maximum torque for the internal combustion engine.

According to one embodiment, there is provided a method of operating an exhaust system. The exhaust system comprises an internal combustion engine, an exhaust throttle valve, and a pressure sensor. The method comprises the steps of: outputting an exhaust gas from the internal combustion engine; determining a flow factor for the exhaust throttle valve; determining a worst-case pressure estimate based on the flow factor; conducting a diagnostic pressure analysis when the worst-case pressure estimate is higher than a hardware pressure limit, wherein the diagnostic pressure analysis determines whether a current pressure measure from one or more pressure readings from the pressure sensor is greater than the hardware pressure limit; estimating a stuck position for the exhaust throttle valve when the current pressure measure is greater than the hardware pressure limit; and maintaining diagnostic pressure analysis monitoring when the current pressure measure is less than the hardware pressure limit.

According to various embodiments, this method may further include:
the step of mitigating one or more exhaust system effects based on the flow limit and/or the estimated stuck position.

According to another embodiment, there is provided an exhaust system for a vehicle comprising an internal combustion engine; a pressure sensor downstream of the internal combustion engine; an exhaust throttle valve downstream of the pressure sensor, the exhaust throttle valve having a flap and a main shaft with a linkage between the flap and the main shaft; and an electronic control unit configured to use one or more pressure readings from the pressure sensor to estimate a stuck position of the flap of the exhaust throttle valve when the linkage between the flap and the top shaft fails.

According to various embodiments, this system may further include any one of the following features or any technically-feasible combination of these features:
the electronic control unit is further configured to adjust a torque command for the internal combustion engine to mitigate one or more exhaust system effects; and/or
the linkage connects a flap shaft of the flap and the main shaft.

### BRIEF DESCRIPTION OF THE DRAWINGS

Preferred exemplary embodiments will hereinafter be described in conjunction with the appended drawings, wherein like designations denote like elements, and wherein:

FIG. 1 is a schematic representation of a vehicle exhaust system according to one embodiment;

FIG. 2 is cross-section view of an exhaust throttle valve of the exhaust system of FIG. 1;

FIG. 3 is an enlarged view of a linkage of the exhaust throttle valve of FIG. 2;

FIG. 4 is a flowchart illustrating a method of operating an exhaust system, such as the exhaust system of FIG. 1; and

FIG. 5 is a flowchart illustrating substeps of one of the method steps of FIG. 4; and

FIG. 6 is a graph showing flow factor plotted against an upstream pressure measure.

### DETAILED DESCRIPTION

The system and method described herein relate to an exhaust system that can more efficiently detect problems with the exhaust throttle valve, and mitigate exhaust system effects that may result due to increased backpressure in the exhaust line. More particularly, failure in a linkage between the main actuating shaft of the exhaust throttle valve and the valve flap may result in the valve flap becoming stuck in a certain position. This may cause undesirable effects on the exhaust system, such as hot gas leakage due to sealing or fastening failure on one or more components of the exhaust line, exhaust temperature increase or over temperature, compressor or turbocharger damage, and/or other exhaust line components damage. The present system and method can efficiently detect a linkage failure and mitigate one or more of these undesirable effects.

### System—

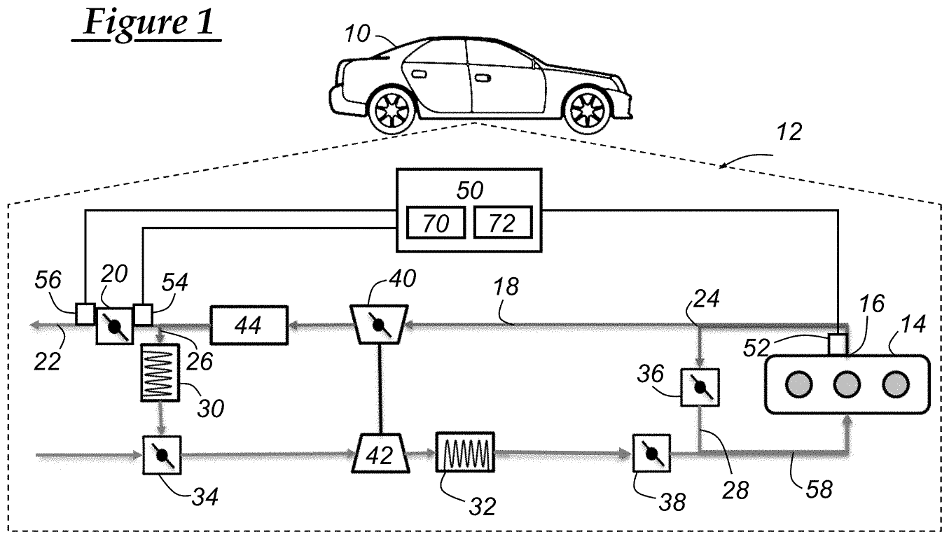

FIG. 1 shows a schematic representation of an example vehicle 10 equipped with an exhaust system 12. It should be appreciated that the exhaust systems and methods described herein may be used with any type of vehicle, including traditional passenger vehicles, sports utility vehicles (SUVs), cross-over vehicles, trucks, vans, buses, recreational vehicles (RVs), etc. These are merely some of the possible applications, as the exhaust system 12 and method described herein are not limited to the exemplary embodiment shown in the figures and could be implemented with any number of different vehicles.

According to one embodiment, the exhaust system 12 includes an internal combustion engine 14, an exhaust output 16, and an exhaust line 18. The exhaust throttle valve 20, which is detailed further below, can help control the amount of exhaust gas diverted between an exhaust output 22 and an exhaust gas recirculation (EGR) system 24, which includes a low pressure (LP) loop 26 and a high pressure (HP) loop 28, in this embodiment. The LP loop 26 includes various heaters and/or coolers 30, 32 for controlling the exhaust temperature, as well as an EGR valve 34 for controlling exhaust and air intake. Intake valves 36, 38 control the amount of exhaust and charge air that is used for combustion in the internal combustion engine 14. Also included in this embodiment is a turbine 40 and main compressor 42, and an aftertreatment device 44. Operation of various components of the system 12, may be accomplished with an electronic control unit (ECU) 50. Various sensors may provide information to the ECU 50 to operate the components of the exhaust system 12, including but not limited to, a main engine exhaust pressure and temperature sensor 52, an upstream exhaust pressure and temperature sensor 54, and a downstream exhaust pressure and temperature sensor 56. As used herein, the terms “downstream” and upstream” are generally in reference to the primary direction of airflow A through the exhaust system 12. Further, it is possible for the sensors 54, 56 to be located further downstream or further upstream than what is indicated, or to be integrated with the valve 20, for example, as the system 12 in FIG. 1 is merely a schematic representation.

Any number of different sensors, components, devices, modules, systems, etc. may provide the exhaust system 12 with information, data and/or other input. These include, for example, the components shown in FIG. 1 and sensors 52, 54, 56, listed above, as well as others that are known in the art but are not shown here. For example, the system may include a coolant level and temperature sensor, a humidity sensor, an oil level and temperature sensor, a fuel rail pressure sensor, a cam position sensor, a crank position sensor, an accelerator pedal position sensor, to cite a few possibilities. It should be appreciated that the various components of the exhaust line 18, as well as any other component that is a part of and/or is used by the exhaust system 12, may be embodied in hardware, software, firmware or some combination thereof. These components may directly sense or measure the conditions for which they are provided, or they may indirectly evaluate such conditions based on information provided by other sensors, components, devices, modules, systems, etc. Furthermore, these components may be directly coupled to the ECU 50, indirectly coupled via other electronic devices, a vehicle communications bus, network, etc., or coupled according to some other arrangement known in the art. These components may be integrated within another vehicle component, device, module, system, etc. (e.g., sensors that are associated a powertrain control module (PCM), an emissions control system, a fuel economy mode, etc.), they may be stand-alone components (as schematically shown in FIG. 1), or they may be provided according to some other arrangement. In some instances, multiple sensors might be employed to sense a single parameter (e.g., for providing redundancy). It should be appreciated that the foregoing scenarios represent only some of the possibilities, as any type of suitable arrangement or architecture may be used to carry out the methods described herein. For example, it is possible for the sensors and/or other components to be arranged in a different configuration.

The internal combustion engine 14 can be a diesel or gasoline powered engine to cite two examples, although an alternate fuel source may be used. The engine 14 has one or more cylinders with a piston. The piston rotates a crankshaft via volumetric changes in the combustion chamber due to ignition and combustion of an air fuel mixture. The representation of the exhaust system 12 and engine 14 is schematic, and accordingly, other features not illustrated may be provided, such as a fuel injection system, various valves or shafts, etc. The throttle or intake valve 38 can regulate the flow of air into an intake manifold 58 for controlled distribution of air into the engine 14. In some embodiments, the vehicle 10 is a hybrid vehicle such that the internal combustion engine 14 is not the only source of motive power, and additional motive power may be provided by an electric motor/generator or another power source.

The main compressor 42 in this embodiment is a forced air system turbocharger. The main compressor 42 is rotationally coupled to the turbine 40. Rotation of the main compressor 42 increases the pressure and temperature of air in the LP loop 26 and accordingly in the manifold 58. The cooler 32 may accordingly be provided, such as a water charged air cooler, to reduce the temperature of the air. The turbine 40 rotates by receiving exhaust from the engine exhaust output 16, which directs exhaust from each of the cylinders. Exhaust exits the turbine 40 and is directed toward the aftertreatment device 44. The turbocharger may include a variable geometry turbine (VGT) with a VGT actuator arranged to move the vanes to alter the flow of exhaust through the turbine 40. In other embodiments, the main compressor 42 may have a fixed geometry turbine or include a waste gate.

The aftertreatment device 44 treats exhaust from the engine exhaust output 16. The aftertreatment device 44 may be any device that is configured to change the composition of the exhaust. Some examples include, but are not limited to, catalytic converters (two or three way), oxidation catalysts, lean NOx traps, hydrocarbon adsorbers, selective catalytic reduction (SCR) systems, and particulate filters. The aftertreatment device 44 may not be a separate or stand-alone device, as it may be associated with another component of the system 12 such as the turbine 40. After exposure to the aftertreatment device 44 a portion of the exhaust may be routed through the exhaust throttle valve 20 and out of the exhaust outlet or pipe 22.

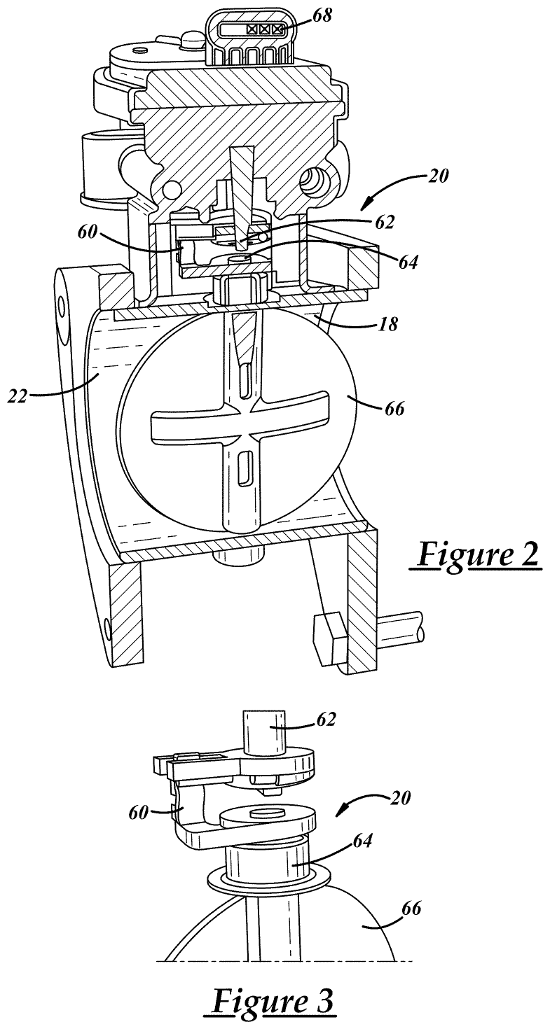

FIGS. 2 and 3 illustrate the exhaust throttle valve 20 and its various components, including a linkage 60 between a main shaft 62 and a flap shaft 64 for changing the position of the flap 66 in the exhaust line 18, thereby controlling the amount of exhaust gas output in pipe or output line 22. The linkage 60 is a stiff linkage which transmits torque from a command gear connected to the main shaft 62 to the flap shaft 64 to actuate the valve 20. A position sensor 68 can be used to help indicate the position of one or more of the shafts 62, 64 and/or the flap 66, but sometimes the position sensor 68 may not provide a reliable enough reading to detect failure of the linkage 60. When the linkage 60 fails, the flap 66 maintains the position it was in at the time of failure. Accordingly, there is a risk that the flap 66 of the exhaust throttle valve 20 could be stuck at a maximum closed position for a complete driving cycle without any remedy or indication of the problem. The system and method disclosed herein can address this problem and mitigate undesirable effects on the exhaust system 12, such as hot gas leakage due to sealing or fastening failure on one or more components of the exhaust line 18, exhaust temperature increase or over temperature, compressor 42 or turbocharger damage, and/or other exhaust line components damage. Moreover, it is possible for the method herein to be applicable to other exhaust throttle valve configurations. For example, the present methods may be able to detect a stuck flap in valves having more unitary throttle actuator shaft structures.

Returning to FIG. 1, ECU 50 can be configured to use one or more pressure readings from one or more of the pressure sensors 52, 54, 56 to determine a position of the flap 66 of the exhaust throttle valve 20, such as when the linkage 60 between the flap shaft 64 and the main shaft 62 breaks. It is possible for the ECU 50 to control other components in the exhaust system 12 beyond what is specifically illustrated and described herein. Accordingly, the ECU 50 may obtain feedback or information from numerous sources, such as sensors not particularly illustrated herein, an engine or powertrain control module, etc. The ECU 50 may be considered a controller, a control module, etc., and may include any variety of electronic processing devices, memory devices, input/output (I/O) devices, and/or other known components, and may perform various control and/or communication related functions. In an example embodiment, ECU 50 includes an electronic memory device 70 that stores sensor readings (e.g., sensor readings from sensors 52, 54, 56), look up tables or other data structures (e.g., look up tables relating to the calibratable flow factors and flow limits described below), algorithms (e.g., the algorithm embodied in the method described below), etc. The memory device 70 may maintain a buffer consisting of data collected over a predetermined period of time or during predetermined instances (e.g., flow factor as a function of changes in engine torque). The memory device 70, or just a portion thereof, can be implemented or maintained in the form of an electronic data structure, as is understood in the art. ECU 50 also includes an electronic processing device 72 (e.g., a microprocessor, a microcontroller, an application specific integrated circuit (ASIC), etc.) that executes instructions for software, firmware, programs, algorithms, scripts, etc. that are stored in memory device 70 and may partially govern the processes and methods described herein.

Depending on the particular embodiment, the ECU 50 may be a stand-alone vehicle electronic module (e.g., an engine controller, a specialized exhaust system or EGR controller, etc.), it may be incorporated or included within another vehicle electronic module (e.g., a powertrain control module, an automated driving control module, etc.), or it may be part of a larger network or system (e.g., an automated driving system, a fuel efficiency system, etc.), to name a few possibilities. Accordingly, the ECU 50 is not limited to any one particular embodiment or arrangement and may be used by the present method to control one or more aspects of exhaust system 12 operation. The ECU 50 may also provide command or torque signals to engine 14, or may provide such a command or signal to another device or module to control operation of engine 14. Additionally, the ECU 50 may interact with other components, such as a body control module, an infotainment system to notify a user of the vehicle 10 of potential problems with the exhaust system 12, or other vehicle systems. The exhaust system 12 and/or ECU 50 may also include a calibration file, which is a setup file that defines the commands given to the actuating components such as the exhaust throttle valve 20 and/or the engine 14. The commands govern the exhaust system 12 and may include, for example, the ability to adjust a torque command for the engine 14 based on a modified maximum torque suitable based on the position of the flap 66 of the exhaust throttle valve 20.

### Method—

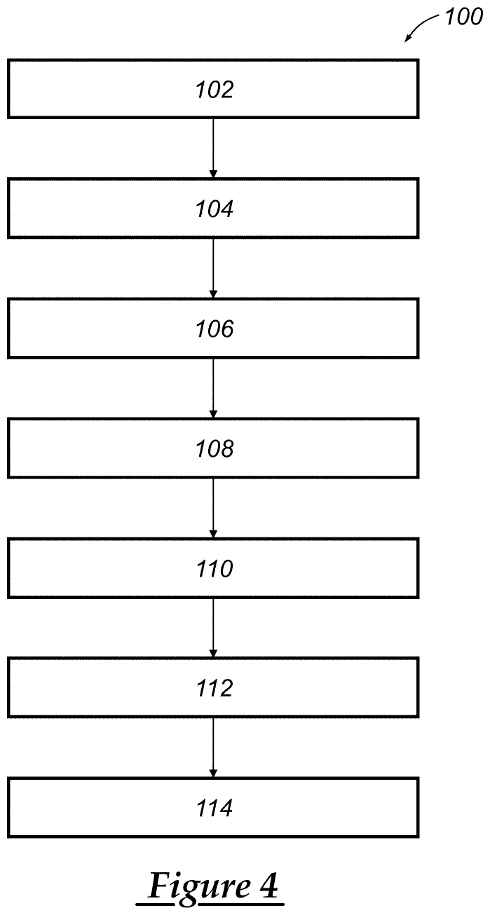

FIG. 4 illustrates a method 100 for operating an EGR system using the system described above with respect to FIG. 1. It should be understood that the steps of the method 100 are not necessarily presented in any particular order and that performance of some or all the steps in an alternative order is possible and is contemplated. Further, it is likely that the method 100 could be implemented in other systems that are different from the system 12 illustrated in FIG. 1 or with an exhaust throttle valve that is configured differently than the valve 20 illustrated in FIGS. 2 and 3, and that the description of the method 100 within the context of the system 12 and exhaust throttle valve 20 is only an example.

The method 100 begins at step 102, by outputting exhaust from an internal combustion engine. Exhaust resulting from the combustion of the air/fuel mixture in the engine 14 enters the exhaust line 18. The exhaust includes various by-products such as NOx, CO2, and H2O. The ECU 50 can monitor one or more qualities or conditions relating to the output of exhaust, with the engine exhaust pressure and temperature sensor 52, to cite one example. At least a portion of the exhaust may be circulated through an aftertreatment device, such as aftertreatment device 44, to change a composition of the exhaust. This step may involve reducing particulate matter in the exhaust, such as with a particulate filter, or chemically changing the composition of the exhaust, such as with a catalytic converter, an oxidation catalysts or SCR system. The use of lean NOx traps or hydrocarbon adsorbers is also possible, as are other aftertreatment procedures that alter the exhaust. Additionally, at least some of the exhaust may be routed through the LP loop 26 and/or the HP loop 28. The portion of the exhaust that is not used for EGR purposes may be output from the system via exhaust throttle valve 20 and exhaust pipe 22.

Step 104 involves determining a flow factor for the exhaust throttle valve 20. In one embodiment, the flow factor is proportional to the mass flow through the valve 20 and the exhaust gas temperature. In another embodiment, the flow factor is also proportional to the downstream valve pressure, and may be determined using the following equation:

$$Flow Factor ∝ \frac{Flow \times Temperature}{Downstream Pressure} \qquad Equation 1$$

The flow factor may be derived by the ECU 50, for example, from information received from one or more sensors 52, 54, 56. The flow factor, in one example, can be determined from a calibratable array as a function of the main compressor flow, exhaust temperature, and or downstream pressure, as measured or derived, for example, from one or more sensor readings from downstream pressure sensor 56. When the exhaust throttle valve 20 is stuck in a position in which the flap 66 is closed or almost closed (e.g., 85-100% or 90-100% blocking the exhaust line 18), the downstream pressure in the exhaust pipe 22 will generally remain low. However, the upstream pressure in the exhaust line 18 will be much higher than under circumstances of proper operation of the exhaust throttle valve 20. The upstream pressure can depend on the flow factor, which may take into account the mass flow through the valve 20, the exhaust gas temperature, downstream valve pressure, and possible valve position. The flow factor, as described below, can be used to identify possible conditions in which the exhaust throttle valve 20 is stuck in a position in which the flap 66 is closed or almost closed.

Step 106 of the method involves determining a worst-case pressure estimate. The worst-case pressure estimate may be derived or provided by the ECU 50, for example. The worst-case pressure estimate, in one embodiment, is a pressure amount on the exhaust throttle valve 20 when the flap 66 is stuck at maximum closure for the flow factor determined in step 104. In general, when the flow factor takes into account flow, temperature, and downstream pressure, as detailed above with regard to Equation 1, for these various conditions of the system 12, step 106 will calculate what the maximum pressure would be if the flap 66 of the valve 20 is closed, given these conditions. The worst-case pressure estimate can be used in the diagnostic pressure analysis described below.

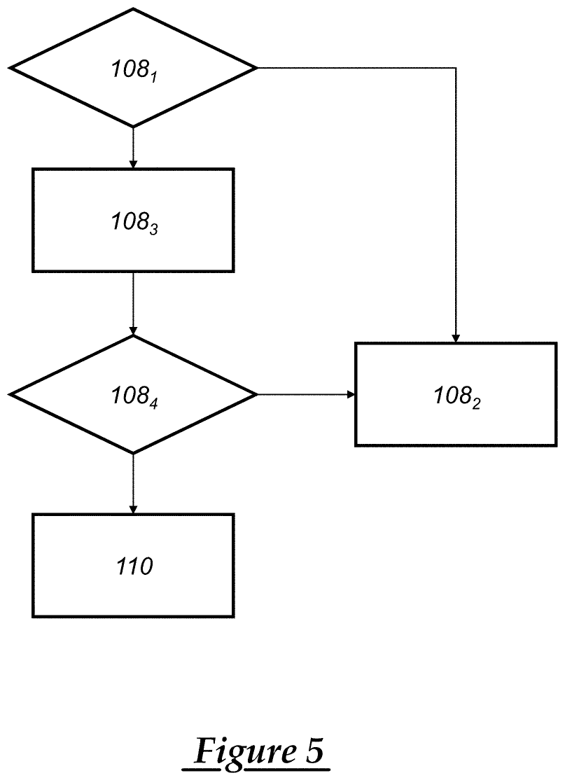

Step 108 of the method involves conducting a diagnostic pressure analysis. This may be accomplished using one or more pressure readings from one of the pressure sensors 52, 54, 56. In one embodiment, the diagnostic pressure analysis may be conducted in accordance with substeps 108₁, 108₂, 108₃, 108₄ in FIG. 5. Further, one or more of the substeps 108₁, 108₂, 108₃, 108₄ may be implemented using ECU 50.

Substep 108₁ is a threshold step of determining whether the worst-case pressure estimate from step 106 is higher than a hardware pressure limit. The hardware pressure limit on the exhaust throttle valve 20 or one of its subcomponents, the hardware pressure limit on one of the other components on exhaust line 18 (e.g., turbine 40 or main compressor 42), or a calibratable average of the hardware pressure limits of a plurality of different components in the exhaust system 12, to cite a few examples. The hardware pressure limit may be the pressure amount that is likely to cause damage to the one or more components described above, or result in a sealing or fastening failure. When the worst-case pressure estimate from step 106 is not higher than the hardware pressure limit, the method may continue monitoring in step 108₂. However, when the worst-case pressure estimate is higher than the hardware pressure limit, the method may activate the diagnostic pressure analysis in substep 108₃. References herein to “higher than,” “lower than,” etc. are meant to include implementations of “higher than” or “higher than or equal to” as well as “lower than” or “lower than or equal to,” etc.

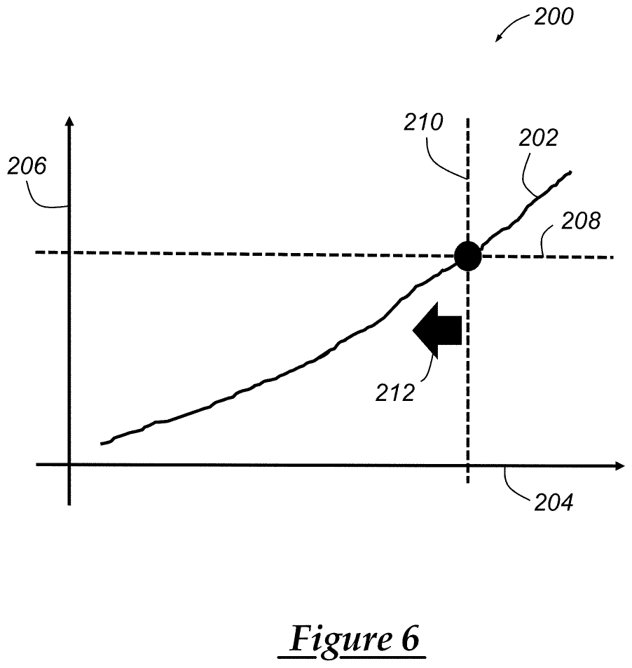

After the diagnostic pressure analysis is activated in substep 108₃, substep 108₄ determines whether a current pressure measure is higher than the hardware pressure limit. The current pressure measure may be derived or determined from one or more pressure readings from one of the sensors 52, 54, 56, but in an advantageous embodiment, substep 108₄ uses one or more pressure readings from the upstream pressure sensor 54. The upstream pressure sensor 54 is advantageous because it is more indicative of a problem scenario than the downstream pressure (e.g., overpressure will be present upstream of valve 20, not downstream in the case of valve failure at maximum or almost maximum closure). FIG. 6 is a graph 200 which is a plot 202 of the flow factor of step 102 on the x-axis 204 and the upstream current pressure measure on the y-axis 206. The horizontal dotted line 208 is the hardware pressure limit, and where the line 208 intersects with the plot 202 (dotted line 210) indicates the maximum safe flow factor. Accordingly, as indicated by the arrow 212, any flow factors less than this maximum are acceptable. If the current pressure measure is not higher than the hardware pressure limit, the method may continue or maintain diagnostic pressure monitoring in substep 108₂. This continued monitoring may occur, because, there is not likely to be damage to the various components of the exhaust system 12. However, once the current pressure measure is higher than the hardware pressure limit, the method may continue to step 110 in FIG. 4 to help mitigate possible undesirable impacts on the exhaust system 12.

Returning to FIG. 4, step 110 involves estimating a stuck position for the flap 66 of the exhaust throttle valve 20. In one embodiment, the stuck position is estimated by assuming the stuck position is the worst-case position (e.g., blocks 100% of exhaust pipe 22 such that all exhaust is rerouted through the LP loop 26 and/or the HP loop 28). In another embodiment, the stuck position is ascertainable via a lookup table, a calibratable array or the like which takes into account a flow reading or calculation (e.g., the flow factor), one or more temperature readings, and one or more pressure readings from one or more of the sensors 52, 54, 56. The step of estimating a stuck position may take into account readings from the position sensor 68 as well, in some implementations, and may be accomplished through use of ECU 50.

Step 112 involves determining a flow limit based on the stuck position estimated in step 110. This may be derived or calculated by the ECU 50. In one embodiment, this step calculates a maximum flow through the exhaust throttle valve 20 that is able to maintain the pressure below the limit (e.g. dotted line 208 in FIG. 6). The maximum acceptable flow can allow the exhaust system 12 to operate without the likelihood of damaging the system components due to the inability of the valve 20 to operate properly. For example, if the estimated stuck position is 85%, the flow limit is the amount of exhaust pressure upstream of the valve 20 that can be tolerated when the maximum amount of exhaust gas that will be output via pipe 22 is only 15%. Other examples for the flow limit are certainly possible.

Step 114 mitigates one or more effects on exhaust system 12 based on the flow limit calculated in step 112 and/or the stuck position estimated in step 110. Step 114 may be accomplished directly by ECU 50, or indirectly by ECU, such as when the ECU sends a signal regarding engine operation to an engine control module, powertrain control module, etc. In one embodiment, mitigation may involve notifying the driver or user of the vehicle 10 that there is a potential problem with the exhaust system 12. This can allow the user to stop driving or otherwise disable the vehicle 10 until it can be fixed. In another embodiment, mitigation may involve activating a diagnostic trouble code (DTC), which can serve to warn the driver or user of the vehicle 10.

In an advantageous embodiment, step 114 determines a modified maximum torque for the internal combustion engine 14. The modified maximum torque can then be used to adjust a torque command for the internal combustion engine 14. Lowering the torque can reduce the flow factor into an acceptable range in which damage to one or more components of the system 12 is unlikely (e.g., as indicated by arrow 212 in FIG. 6). The modified maximum torque is typically dependent on the flow limit calculated in step 112. The maximum amount of flow that is acceptable can correlate with the amount of torque reduction. Accordingly, the modified maximum torque may be calibratable and dependent on various factors such as flow, temperature, capabilities of the EGR system 24, the hardware pressure limits, etc.

These above examples and the outputs of the method 100 will vary depending on factors such as the exhaust system, the driving mode, capabilities of the EGR system 24, as well as other characteristics. For example, mitigation may include modifying a speed request as opposed to modifying a torque request. Further, as opposed to just waiting for damage to occur, the method 100 can preemptively diagnose and mitigate issues while the vehicle 10 is being driven. This can minimize potential damage to one or more components of the exhaust system 12.

It is to be understood that the foregoing description is not a definition of the invention, but is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. For example, the specific combination and order of steps is just one possibility, as the present method may include a combination of steps that has fewer, greater or different steps than that shown here. All such other embodiments, changes, and modifications are intended to come within the scope of the appended claims.

As used in this specification and claims, the terms “for example,” “e.g.,” “for instance,” “such as,” and “like,” and the verbs “comprising,” “having,” “including,” and their other verb forms, when used in conjunction with a listing of one or more components or other items, are each to be construed as open-ended, meaning that that the listing is not to be considered as excluding other, additional components or items. Other terms are to be construed using their broadest reasonable meaning unless they are used in a context that requires a different interpretation.

What is claimed is:

1. A method of operating an exhaust system for a vehicle, the exhaust system comprising an internal combustion engine, an exhaust throttle valve, and a pressure sensor, the method comprising the steps of:
outputting an exhaust gas from the internal combustion engine;
determining a flow factor for the exhaust throttle valve;
conducting a diagnostic pressure analysis using one or more pressure readings from the pressure sensor;
estimating a stuck position for the exhaust throttle valve;
determining a flow limit based on the estimated stuck position; and
mitigating one or more exhaust system effects based on the flow limit and/or the estimated stuck position.

2. The method of claim 1, wherein the flow factor is proportional to a mass flow rate through the exhaust throttle valve and an exhaust gas temperature.

3. The method of claim 2, wherein the flow factor is also proportional to a downstream pressure measure.

4. The method of claim 3, wherein the pressure sensor is a downstream pressure sensor, and wherein the one or more pressure readings are obtained from downstream of the exhaust throttle valve and used to determine the downstream pressure measure.

5. The method of claim 1, wherein the flow factor is used to determine a worst-case pressure estimate.

6. The method of claim 5, wherein the diagnostic pressure analysis comprises a threshold step of determining whether the worst-case pressure estimate is higher than a hardware pressure limit.

7. The method of claim 6, wherein when the worst-case pressure limit is higher than the hardware pressure limit, the diagnostic pressure analysis determines whether a current pressure measure from the one or more pressure readings is higher than the hardware pressure limit.

8. The method of claim 7, wherein the pressure sensor is an upstream pressure sensor and the one or more pressure readings are obtained from upstream of the exhaust throttle valve.

9. The method of claim 1, wherein the step of estimating a stuck position for the exhaust throttle valve uses a flow reading or calculation, one or more temperature readings, and the one or more pressure readings.

10. The method of claim 1, wherein the step of mitigating one or more exhaust system effects includes activating a diagnostic trouble code.

11. The method of claim 1, wherein the step of mitigating one or more exhaust system effects includes determining a modified maximum torque for the internal combustion engine.

12. The method of claim 11, further comprising the step of adjusting a torque command for the internal combustion engine based on the modified maximum torque for the internal combustion engine.

13. A method of operating an exhaust system for a vehicle, the exhaust system comprising an internal combustion engine, an exhaust throttle valve, and a pressure sensor, the method comprising the steps of:
outputting an exhaust gas from the internal combustion engine;
determining a flow factor for the exhaust throttle valve;
determining a worst-case pressure estimate based on the flow factor;
conducting a diagnostic pressure analysis when the worst-case pressure estimate is higher than a hardware pressure limit, wherein the diagnostic pressure analysis determines whether a current pressure measure from one or more pressure readings from the pressure sensor is greater than the hardware pressure limit;
estimating a stuck position for the exhaust throttle valve when the current pressure measure is greater than the hardware pressure limit; and
maintaining diagnostic pressure analysis monitoring when the current pressure measure is less than the hardware pressure limit.

14. The method of claim 13, further comprising the step of mitigating one or more exhaust system effects based on the flow limit and/or the estimated stuck position.

15. An exhaust system for a vehicle, comprising:
an internal combustion engine;
a pressure sensor downstream of the internal combustion engine;
an exhaust throttle valve downstream of the pressure sensor, the exhaust throttle valve having a flap and a main shaft with a linkage between the flap and the main shaft; and
an electronic control unit configured to use one or more pressure readings from the pressure sensor to estimate a stuck position of the flap of the exhaust throttle valve when the linkage between the flap and the top shaft fails.

16. The exhaust system of claim 15, wherein the electronic control unit is further configured to adjust a torque command for the internal combustion engine to mitigate one or more exhaust system effects.

17. The exhaust system of claim 15, wherein the linkage connects a flap shaft of the flap and the main shaft.
